(19) United States
(12) Patent Application Publication
(10) Pub. No.: US 2015/0323154 A1
(43) Pub. Date: Nov. 12, 2015

(54) FUSE TYPE VEHICLE LIGHT

(71) Applicant: Young-Hwan JANG, (US)

(72) Inventor: YOUNG-HWAN JANG, SEOUL (KR)

(21) Appl. No.: 14/652,754

(22) PCT Filed: Dec. 13, 2013
(86) PCT No.: PCT/KR2013/011617

§ 371 Date: Jun. 16, 2015

(30) Foreign Application Priority Data
Dec. 27, 2012 (KR) 10-2012-0154880

(51) Int. Cl. F21V 5/04; B60Q 3/06; F21K 99/00

(52) U.S. Cl. CPC F21V 5/04; F21K 9/17; B60Q 3/06; F21Y 2101/02

(57) ABSTRACT

A fuse type vehicle light includes topknot bases formed apart from each other in a predetermined interval. A substrate unit is positioned between the topknot bases and equipped with a light-emitting diode (LED). A floodlight unit is positioned on an upper portion of the substrate unit and configured to diffuse light emitted from the LED. A heat radiation unit is positioned on a lower portion of the substrate unit and configured to discharge heat generated in the substrate unit to outside. The floodlight unit includes a lens unit to diffuse light to an inner portion so as to form a light radiation width in the range of 50-70° and the light is evenly diffused inside a trunk of a vehicle, thereby improving the uniformity of overall brightness of the LED.

### TECHNICAL FIELD

The present invention relates to a fuse type vehicle light that is installed inside a trunk of a vehicle, and more particularly, to a fuse type lamp or light that is provided with a lens unit positioned on an upper portion of a light emitting diode (LED) and having an inner diameter and an outer diameter different from each other, so that light is efficiently diffused by widening the width of the light radiated from an LED element.

### BACKGROUND ART

Generally, indoor and outdoor spaces of all vehicles are equipped with a light for illuminating the indoor and outdoor spaces, and a lamp is normally inserted inside the indoor and outdoor lights.

FIG. 1 relates to “a fuse type light” filed for an application by an applicant of the present invention, and more particularly, to a fuse type light including topknot bases 1 and 1′ formed apart from each other in a predetermined interval, a floodlight tube 2 positioned between the topknot bases 1 and 1′, and a light emission unit 3 formed inside the floodlight tube, wherein the light emission unit 3 includes a contact terminal 4 supplying power to both sides of a printed circuit board (PCB).

The fuse type light according to the related art is capable of conducting electricity by having the contact terminal attached to a mounting hole formed on one side of a substrate. However, the electric flow is disconnected when the contact terminal is detached from the substrate due to external pressure.

### RELATED ART DOCUMENT

(Patent Document 1) Korea Patent Application No. 10-2011-0004468

### DISCLOSURE

### Technical Problem

Accordingly, the present invention has been made in view of the above-mentioned problem occurring in the related art, and it is an object of the present invention to provide a fuse type vehicle light that has a lens unit formed with different inner and outer diameters inside a floodlight tube, thus widening the width of light radiated from an LED element and efficiently diffusing the light.

### Technical Solution

To accomplish the above-mentioned object, according to the present invention, there is provided a fuse type vehicle light including: topknot bases formed apart from each other in a predetermined interval; a substrate unit having an LED positioned between the topknot bases; a floodlight unit positioned on an upper portion of the substrate unit and capable of diffusing light emitted from the LED; and a heat radiation unit 40 positioned on a lower portion of the substrate unit and capable of discharging heat generated in the substrate unit to the outside, wherein the floodlight unit further includes a lens unit to diffuse light to an inner portion.

According to the present invention, preferably, the substrate unit includes a main body unit having a printed circuit installed to emit light when power is supplied to the LED, and protruding portions respectively positioned at both sides of the main body unit and capable of being respectively inserted inside the topknot bases, wherein the protruding portions protrude outside the topknot bases to be directly connected to a contact terminal outside.

According to the present invention, preferably, the inner portion of the lens unit is formed in a shape of a circular groove while the outer portion is formed in a noncircular shape in which both end portions are cut, thus refracting the LED light twice.

According to the present invention, preferably, the lens unit refracts the LED light twice to form an illumination angle in the range of 50-70°.

### Advantageous Effects

According to the present invention, as aforementioned, the fuse type vehicle light has the lens unit formed with different inner and outer diameters to form light radiation width in the range of 50-70°, so that light is evenly diffused to indoor and outdoor spaces requiring lights, thus improving uniformity of overall brightness.

In addition, both sides of the floodlight tube are gently inclined to be easily coupled to the topknot bases.

### DESCRIPTION OF DRAWINGS

FIG. 1 is a perspective view of a conventional fuse type light.

FIG. 2 is a perspective view of a fuse type vehicle light according to an embodiment of the present invention.

FIG. 3 is a perspective view of a substrate unit of a fuse type vehicle light according to an embodiment of the present invention.

FIG. 4 is a perspective view of a floodlight unit of a fuse type vehicle light according to an embodiment of the present invention.

FIG. 5 is a drawing of a floodlight unit of a fuse type vehicle light according to an embodiment of the present invention.

FIG. 6 is a perspective view of a heat radiation unit of a fuse type vehicle light according to an embodiment of the present invention.

FIG. 7 is a cross sectional view of a fuse type vehicle light according to an embodiment of the present invention.

### BEST MODE FOR INVENTION

The present invention includes a lens unit to control the width of the light emitted from the LED on the substrate, and the light is refracted twice in the lens unit to uniformize brightness.

Hereinafter, a fuse type vehicle light according to the present invention is described in detail with reference to the accompanying drawings. In the description and in the figures, like elements are identified with like reference numerals. In addition, detailed description of the known functions and components that can make the gist of the present invention unnecessarily vague will be omitted.

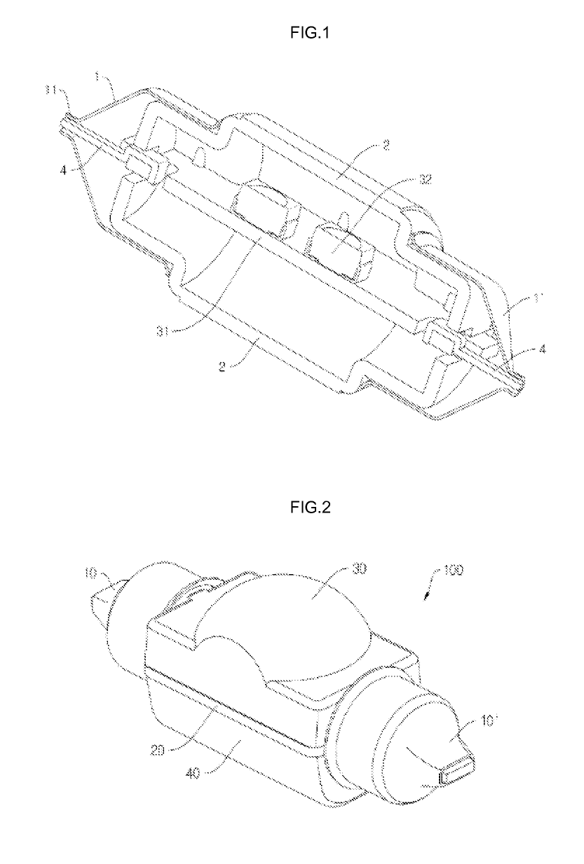

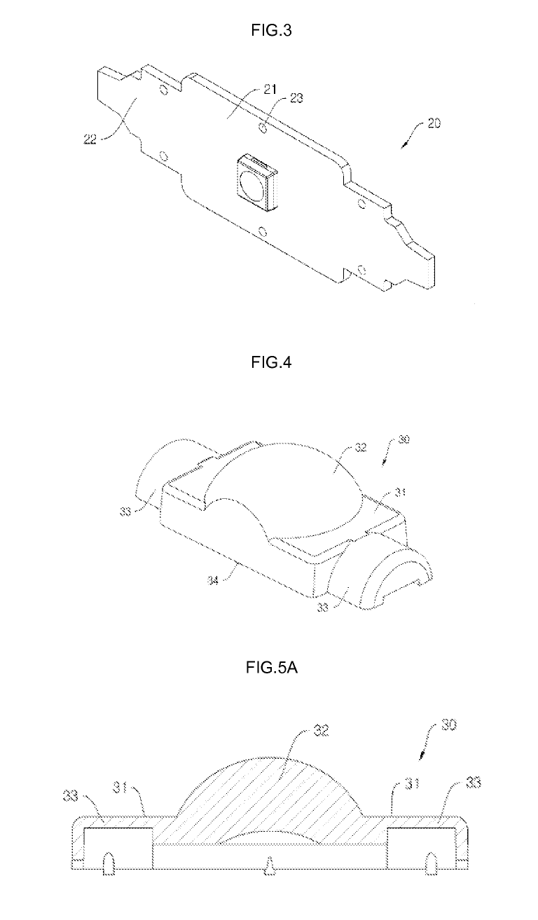

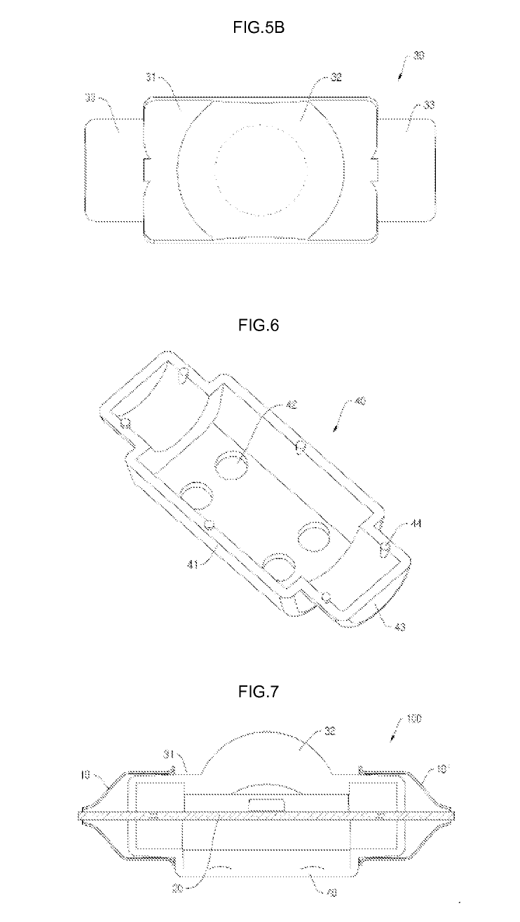

FIG. 2 is a perspective view of a fuse type vehicle light according to an embodiment of the present invention; FIG. 3 is a perspective view of a substrate unit of a fuse type vehicle light according to an embodiment of the present invention; FIG. 4 is a perspective view of a floodlight unit of a fuse type vehicle light according to an embodiment of the present invention; FIG. 5 is a drawing of a floodlight unit of a fuse type vehicle light according to an embodiment of the present invention; FIG. 6 is a perspective view of a heat radiation unit of a fuse type vehicle light according to an embodiment of the present invention; and FIG. 7 is a cross sectional view of a fuse type vehicle light according to an embodiment of the present invention.

As shown in FIG. 2, the fuse type vehicle light 100 includes topknot bases 10 and 10′ formed apart from each other in a predetermined interval, a substrate unit 20 having an LED positioned between the topknot bases 10 and 10′, a floodlight unit 30 positioned on an upper portion of the substrate unit 20 and capable of diffusing light emitted from the LED, and a heat radiation unit 40 positioned on a lower portion of the substrate unit 20 and capable of discharging heat generated in the substrate unit 20.

The topknot bases 10 and 10′ are respectively positioned at both sides of the assembled substrate unit 20, floodlight unit 30, and heat radiation unit 40, and respectively includes through-holes 11 and 11′ formed inside to connect the substrate unit to an external power source in order to conduct electricity.

The topknot bases 10 and 10′ are formed in a cylindrical shape, wherein one side is opened to have portions of the substrate unit 20, floodlight unit 30, and heat radiation unit 40 inserted, and the other side is tapered as a shape of a funnel.

The substrate unit 20 includes a main body unit 21 formed in a quadrilateral shape and having a printed circuit installed to emit light when power is supplied to an LED, and protruding portions 22 respectively positioned at both sides of the main body unit 21 and capable of being respectively inserted inside the topknot bases 10 and 10′. The protruding portions 22 have end portions formed in a trapezoidal shape to respectively correspond to cross sections of the topknot bases 10 and 10′, and one sides of the protruding portions 22 penetrate the through-holes of the topknot bases 10 and 10′ to protrude toward the outside. In addition, the substrate unit 20 includes a plurality of fixing grooves 23 formed along the outer circumferential surface to fix the floodlight unit 30 and the heat radiation unit 40. Accordingly, the protruding portions 22 of the substrate unit 20 protrude outside the topknot bases 10 and 10′ to be directly connected to a contact terminal outside.

The floodlight unit 30 is inserted between the topknot base 10 and the other topknot base 10′, thus emitting light of the LED on the substrate unit 20 to the outside through the floodlight unit 30. The floodlight unit 30 includes a body portion 31 formed in a semi-cylindrical shape, and grip portions 33 respectively positioned at both sides of the body portion 31 and capable of being respectively inserted inside the topknot bases 10 and 10′.

The body portion 31 is formed with transparent material to enable the LED light to be penetrated therethrough and further includes a lens unit 32 formed therein to efficiently diffuse light by widening the light radiation width. The lens unit 32 refracts the LED light twice to form the illumination angle in the range of 50-70°. In other words, the inner portion of the lens unit 32 is formed in a shape of a circular groove while the outer portion thereof is formed in a noncircular shape in which both end portions are cut, thus re-refracting the light emitted through the inner groove by the outer cut portions to restrict the illumination angle.

The heat radiation unit 40 is positioned on the lower portion of the substrate unit 20 and discharges heat generated in the substrate unit 20 to the outside, thus preventing the substrate unit 20 from being damaged by heat. Same with the floodlight unit 30, the heat radiation unit 40 includes a semi-cylindrical body portion 41, and grip portions 43 respectively positioned at both sides of the body portion 41 and capable of being respectively inserted inside the topknot bases 10 and 10′. The only difference is that a plurality of through-holes 42 are formed inside the body portion 41 to discharge heat to the outside.

Meanwhile, a bottom surface of the floodlight unit 30 and a top surface of the heat radiation unit 40 are both opened to be coupled by being positioned at upper and lower portions with respect to the substrate unit 20. Here, a plurality of coupling protrusions 34 and 44 are respectively formed at one sides of the floodlight unit 30 and the heat radiation unit 40 to be mounted on the fixing groove 23 of the substrate unit 20. In other words, the floodlight unit 30 and the heat radiation unit 40 are respectively positioned at upper and lower portions of the substrate unit 20 while the coupling protrusions 34 of the floodlight unit 30 and the coupling protrusions 44 of the heat radiation unit 40 are simultaneously accommodated in the fixing groove 23 of the substrate unit 20, so that the assembled substrate unit 20, floodlight unit 30, and heat radiation unit 40 are not misaligned with each other to be easily coupled when the assembled substrate unit 20, floodlight unit 30, and heat radiation unit 40 are inserted into the topknot bases 10 and 10′.

In addition, the grip portions 33 and 43 of the floodlight unit 30 and the heat radiation unit 40 become progressively inclined toward the outside not to be forcibly fitted into the topknot bases 10 and 10′, thus being easily coupled by a user.

Hereinbefore, various embodiments of the present invention have been described for illustrative purposes, and any changes and modifications within the spirit and scope of the present invention are construed as belonging to the scope of the present invention.

### DESCRIPTION OF REFERENCE NUMERALS

10: topknot bases

20: substrate unit

30: floodlight unit

40: heat radiation unit

1. A fuse type light, comprising:
topknot bases formed apart from each other in a predetermined interval;
a substrate unit positioned between the topknot bases and equipped with an LED;
a floodlight unit positioned on an upper portion of the substrate unit and configured to diffuse an LED light emitted from the LED;
a heat radiation unit positioned on a lower portion of the substrate unit and configured to discharge heat generated in the substrate unit to outside;
wherein the floodlight unit further comprises a lens unit to diffuse the LED light to an inner portion, the inner portion of the lens unit is formed in a shape of a circular groove, and an outer portion of the lens unit is formed in a noncircular shape with both end portions cut to refract the LED light twice to form an illumination angle in the range of 50-70°.

2. The fuse type vehicle light according to claim 1, wherein the substrate unit comprises a main body unit having a printed circuit installed to emit the LED light when power is supplied to the LED, and protruding portions respectively positioned at both sides of the main body unit and configured to be respectively inserted inside the topknot bases, the protruding portions protrudes outside the topknot bases to be directly connected with an external contact terminal.
